(19) United States
(12) Patent Application Publication
(10) Pub. No.: US 2009/0171584 A1
(43) Pub. Date: Jul. 2, 2009

(54) System and Method for Accessing a Navigation System

(75) Inventors: Steven LIU, Thousand Oaks, CA (US); Brant Miller CLARK, Mount Baldy, CA (US); Edward CRUZ, Newbury Park, CA (US)

Correspondence Address: GREENBERG TRAURIG, LLP (SV3), IP DOCKETING, 2450 COLORADO AVENUE SUITE 400E, SANTA MONICA, CA, 90404, US

(73) Assignee: MAGELLAN NAVIGATION, INC., Santa Clara, CA (US)

(21) Appl. No.: 11/967,889

(22) Filed: Dec. 31, 2007

(51) Int. Cl. G01C 21/00; G01S 1/00

(52) U.S. Cl. 701/213; 715/781

(57) ABSTRACT

A user interface is provided as part of a navigation system's user interface that comprises a plurality of screens. An access screen selector is made available in multiple ones of the screens of the navigations system's user interface, which access screen selector corresponds to an access screen. The access screen is displayed as part of the user interface in response to user selection of the access screen selector. The access screen comprises one or more access selection items. Selection of at least one of the of at least one of the access selection items causes the navigation system to perform a search of geographic information to identify a search result using search criteria that can vary from one search to another.

### FIELD OF THE INVENTION

The present disclosure relates to accessing a navigation system, and more particularly to an interface for use by an end user of the navigation system to provide quick access to the navigation system's features and to tools for use by the end user to customize the interface.

### BACKGROUND

Geographic databases exist, which identify geographic, or mapping, information coupled with geographic objects, such as points of interest (POIs), fixed address locations (e.g., street addresses), and the like. A POI can be identified in the geographic database using associated information including geographic location information and other attribute information. Other information that may be stored for a POI includes, but is not limited to, name, address, POI category or type (e.g., city hall, police station, gas station, park, restaurant, etc.) More and more, people are relying on a geographic database, and are using applications that access a geographic database, to locate a POI based on the geographic information associated with the POI. Such applications include navigation systems used in telephones and other handheld devices, desktop computer applications, in automobiles and other vehicles, to name just a few. Improvements in such navigation systems, which facilitate use of the navigation system, would be beneficial.

### SUMMARY

The present disclosure seeks to address failings in the art and to facilitate use of a navigation system including a user-customizable interface to provide easy access to the navigation system by the user.

One or more embodiments provide a method for use with a navigation system and apparatus that comprises a navigation system, such that a user interface comprising a plurality of screens is provided, at least one of the plurality of screens comprises an easy access screen that is made available from other ones of the plurality of screens, the easy access screen comprising a plurality of selections at least one selection of which when selected initiates a pre-stored user-defined search operation to be performed by the system using current search criteria.

In accordance with methods, systems and user interfaces of one or more embodiments if the present disclosure, a user interface is provided as part of a navigation system's user interface that comprises a plurality of screens. An access screen selector is made available in multiple ones of the plurality of screens of the navigations system's user interface, which access screen selector corresponds to an access screen. The access screen is displayed as part of the user interface in response to user selection of the access screen selector. The access screen comprises one or more access selection items. Selection of at least one of the of at least one of the access selection items causes the navigation system to perform a search of geographic information to identify a search result using search criteria that can vary from one search to another.

By virtue of arrangements disclosed herein, a pre-stored user-defined search operation is made available from a plurality of screens of a navigation system's user interface. In accordance with one or more such embodiments, the pre-stored user-defined search operation is made available via a selector displayed in multiple other ones of the user interface screens. The search operation can comprise a search using search criteria that can vary from one search to the next, e.g., a portion of the search criteria is dynamically determined such as a current location. Alternatively, the search operation can comprise a search using search criteria that is fixed for all searches.

In accordance with one or more embodiments, an access screen made available from multiple screens of a navigation system's user interface can be updated by the user, such that the user can modify an access selection item of the access selection screen. For example, the user can associate a fixed or dynamic geographic information search with an access selection items of the access screen, associate an application with an access selection item, jump from one screen of the user interface to another, etc.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 provides an exemplary block diagram illustrating components of a system for use in accordance with one or more embodiments of the present disclosure.

FIG. 2, which comprises FIGS. 2A to 2C, provides examples of panels included in a user interface in accordance with one or more embodiments.

FIG. 3, which comprises FIGS. 3A and 3B, provides an example of an easy access screen flow of process steps for use in accordance with one or more embodiments of the present disclosure.

FIG. 4 provides an example of a screen that includes an easy access panel presented to the user in response to user input to edit/add an easy access panel button in accordance with one or more embodiments of the present disclosure.

FIG. 5 provides a screen showing examples of category selections that can be presented to the user in accordance with one or more embodiments.

FIG. 6 provides an example of a screen and examples of selections made available to the user in response to a user request to associate an access selection item with a category selection in accordance with one or more embodiments of the present disclosure.

FIG. 7, which comprises FIGS. 7A to 7F, provides examples of screens presented in response to a user request to associate an access selection item with a destination in accordance with one or more embodiments of the present disclosure.

FIG. 8, which comprises FIGS. 8A and 8B, provides examples of screens presented in response to a user request to associate an access selection item with a point of interest in accordance with one or more embodiments of the present disclosure.

FIG. 9, which comprises FIGS. 9A and 9B, provides examples of screens presented in response to a user request to associate an access selection item with a contact stored in an address book in accordance with one or more embodiments of the present disclosure.

### DETAILED DESCRIPTION

In general, one or more embodiments of the present disclosure provide a user interface by which a user is able to access at least one operation defined by the user, and by which a user is able to define the at least one operation, and systems, methods, apparatuses and architectures thereof.

Certain embodiments of the present disclosure will now be discussed with reference to the aforementioned figures, wherein like reference numerals refer to like components.

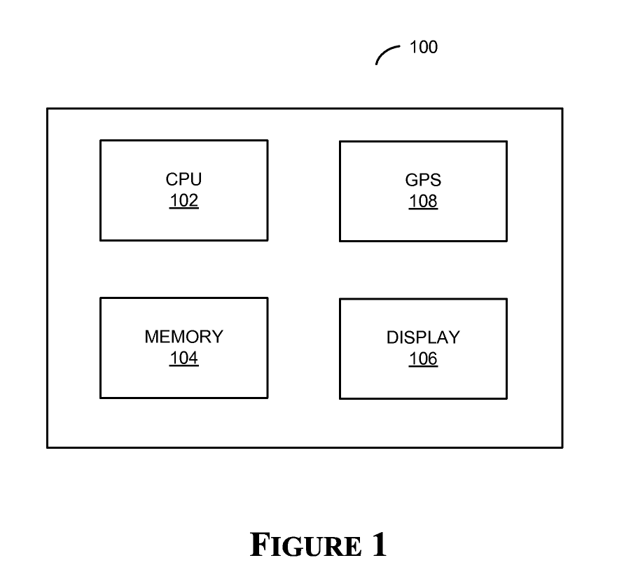

FIG. 1 provides an exemplary block diagram illustrating components of a system for use in accordance with one or more embodiments of the present disclosure. In accordance with one or more such embodiments, a system 100 comprises a central processing unit (CPU) 102, memory 104 and display 106. Display 106 can be used to present a user interface in accordance with one or more embodiments of the present disclosure. In addition and in accordance with one or more embodiments, the system 100 comprises a global positioning system (GPS) 108. The system 100 can comprise a navigation system, such as a navigation system provided in a handheld device, a vehicle navigation system, etc. The modules that comprise the system 100 can be any of hardware, software or firmware, or some combination thereof and can communicate via one or more communications pathways, e.g., a bus.

The memory 104 stores a data store of geographic information that can be accessed by the system 100. Program code also stored in memory 104 can comprise code to configure CPU 102 to implement a navigation system that accesses geographic information from the geographic data store of memory 104. By way of a non-limiting example, the geographic data store comprises geographic information and identifies one or more geographic objects, e.g., points of interest (POIs). A geographic object, such as a POI, is an item, e.g., a discrete item, in the geographic data store, which has at least one corresponding geographic location, and none or more other attributes. A POI's geographic location can be identified using latitude and longitude coordinate data in a latitudinal/longitudinal coordinate system, such as a global positioning system (GPS) 108. Other attribute information can include, without limitation, descriptive information, such as a name, telephone number, type or category (e.g., business, residence, park, street, city, state, etc.), subtype/subcategory (e.g., restaurant, grocery store, gas station, etc.), address, hours of operation, etc.

In accordance with one or more embodiments of the present disclosure, the program code configures the CPU 102 to receive a search request and access the stored geographic information to generate a set of search results in response. It should be apparent that the geographic data store can be any type of data store, including a database management system (DBMS), or other system used to access, e.g., store and retrieve, the geographic information. By way of a further non-limiting example, the data store can comprise flat files stored in file management system.

In accordance with one or more embodiments, in addition to program code and geographic information, the memory 104 stores user-defined searches, e.g., fixed and dynamic searches, destinations, macro operations, contact information, calendar information, etc. In accordance with one or more such embodiments, the program code configures the CPU 102 to display a user interface that includes a set of screens, or panels. The user interface provides a user with an interface to system 100. In accordance with one or more embodiments, one of such panels comprises an easy access panel that is made available via multiple ones of the other panels of the user interface. In accordance with one or more such embodiments, the easy access panel is displayed by system 100 in response to a selection of a selection item, e.g., an icon or other selection, made available in the multiple other panels. In accordance with one or more embodiments, the easy access panel comprises a set of user-defined operations, e.g., fixed search, dynamic search, application invocation/access operations, etc.

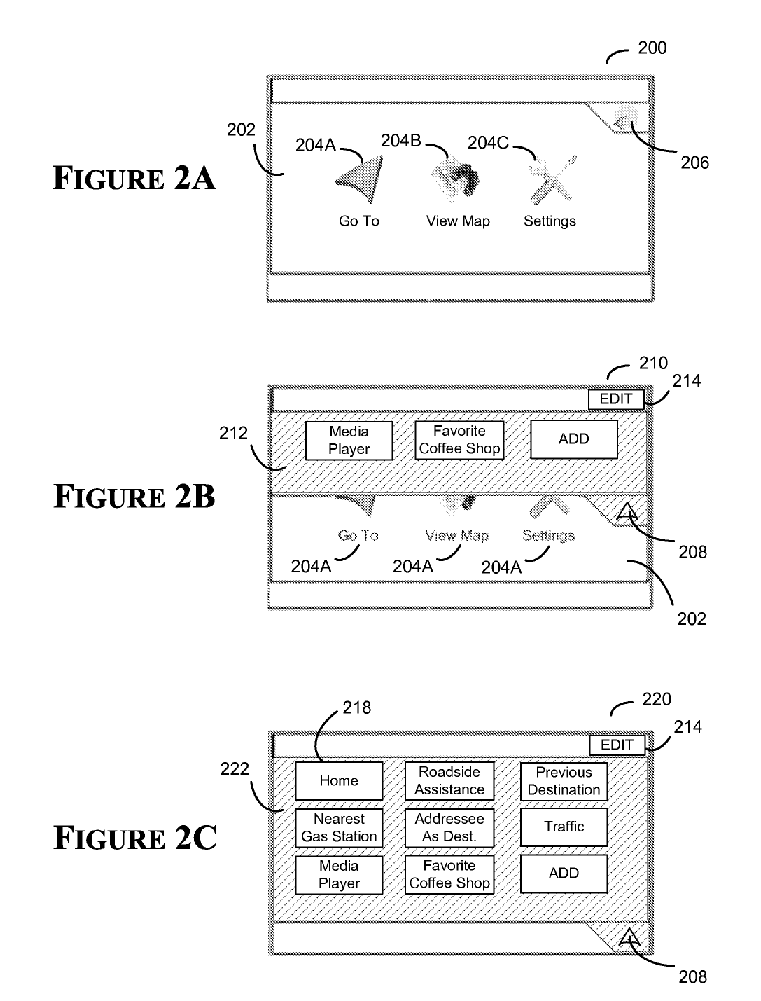

FIG. 2, which comprises FIGS. 2A to 2C, provides examples of panels included in a user interface in accordance with one or more embodiments. Referring to FIG. 2A, screen 200 comprises a set of selections in the form of selection items, buttons, or selections 204. If selected, selection 204A, which in this example comprises an icon and the “Go To” text, results in the user being presented with a screen that allows the user to specify a destination, via one or more additional panels, by address, POI name, intersection, city name, selecting a previous destination, reviewing a book of addresses, for example. By selecting the “View Map” selection 204B, the user is able to view a map. The user is able to specify settings by selecting the “Settings” selection 204C. In addition to these selections, the panel provides an ability to easily access another screen, or panel, which can comprise a number of easy access buttons, including buttons associated with user-defined selections. The user can access the panel via selection item 206.

In accordance with one or more embodiments, the easy access panel appears in a rolling fashion, such that the panel rolls from top to bottom over at least a portion of panel 202 of screen 210, as it “rolls over” the selection items 204. As can be seen from FIG. 2B, the access panel 212 is shown at a point at which it has rolled over a portion of the selection items 204. Panel 212 shown in FIG. 2C has rolled over a portion of panel 202 shown in screens 200 and 210, such that panel 212 partially covers panel 202 and the selection items 204. The easy access panel, which is shown in screen 220 as panel 222 in is fully open state, completely covers panel 202 and selection items 204. Of course it should be apparent that any technique can be used to transition from panel 202 of screen 200 to panel 222 of screen 220.

With reference to FIG. 2C, panel 222 comprises a number of access selection items 218. An access selection item 218 may have previously been defined, e.g., the “Home”, “Roadside Assistance” and “Previous Destination” selections. Other selections, e.g., the “ADD” selections are open, and have not yet been defined. Yet other selections represent buttons that are defined by the user, e.g., “Nearest Gas Station”, “Addressee As Destin.”, “Traffic”, “Media Player”, and “Favorite Coffee Shop”. In accordance with one or more embodiments, a subset of the selections can be reserved, such that the item cannot be deleted and/or edited. In accordance with one or more such embodiments, selection items can be defined or updated by selecting the item 218 and indicating a desire to edit the selected button 218, e.g., by selecting the “EDIT” button 214. Icon 206 is displayed in screen 200 changes to icon 208 in screens 210 and 220, and allows the user to close the easy access panel 212/222. If the user selects icon 208, panel 222 can slide from bottom to top, in reverse of the opening operation, so that panel 202 and selections 204 become visible in the screens 210 and 200.

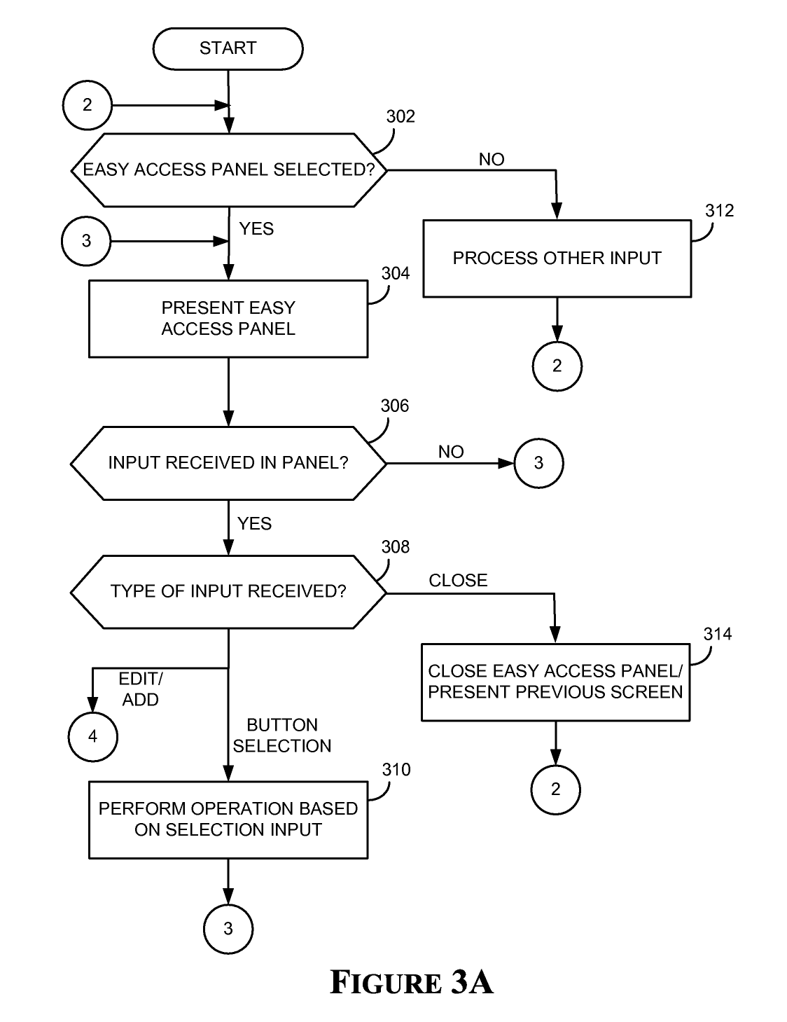

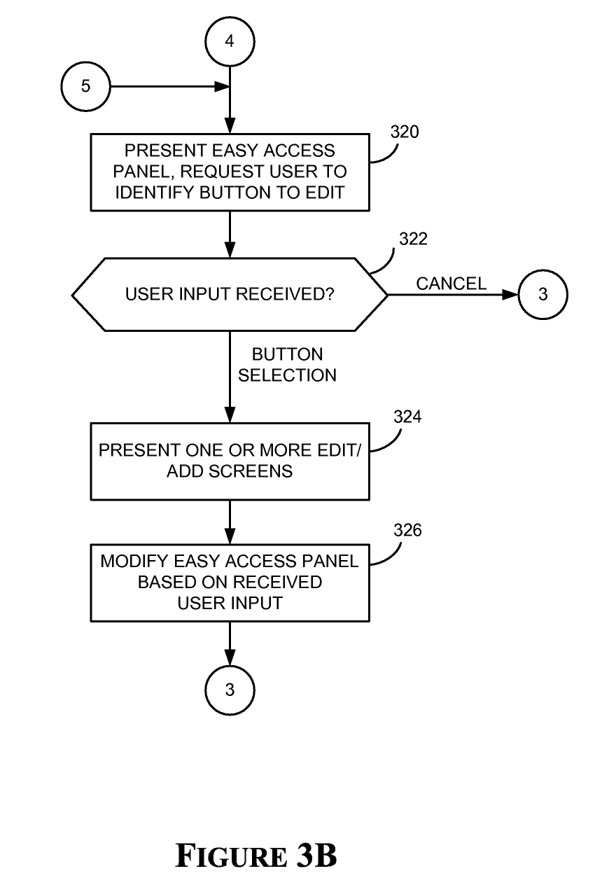

FIG. 3, which comprises FIGS. 3A and 3B, provides an example of an easy access screen flow of process steps for use in accordance with one or more embodiments of the present disclosure. In accordance with one or more embodiments, the process steps are performed by CPU 102 of system 100. The process flow commences at a point that a screen from the user interface is being displayed, which screen includes a selection item, e.g., button 206, to open the easy access panel. At step 302, a determination is made whether or not user input is received from the easy access panel. If it is determined, at step 302, that the user input is not associated with the easy access panel, processing continues at step 310 to process the user input. For example, the system can process user input selecting one of selections 204.

If it is determined at step 302 that the user input indicates that the user intends to access the easy access panel, e.g., the user selected icon 206, processing continues at step 304 to present, or display, the easy access panel, e.g., panel 222. At step 306, a determination is made whether or not user input is received from the easy access panel 222. If not, processing awaits input from the user.

If input is received, processing continues at step 308 to determine the type of input received. If the input is determined to be a request to close the easy access panel 222, processing continues at step 314 to close the easy access panel. For example, the close operation can close the easy access panel, and display a screen that was displayed immediately preceding display of the easy access panel. For example, in a case that screen 200 is displayed prior to displaying screen 220, step 312 can result in screen 200 being presented to the user. Processing then continues at step 302 to await input from the user.

If it is determined at step 306 that the received user input reflects a selection of a button displayed in the easy access panel, processing continues at step 310 to perform the operation associated with the button selected by the user.

If it is determined at step 306 that the received user input is from the easy access panel and that the user wishes to edit the panel, e.g., to add a new selection or edit a previously-defined selection, processing continues at step 320 of FIG. 3B. At step 320, the easy access panel is displayed with a prompt to request that the user indicate which selection, e.g., a button, the user wishes to modify.

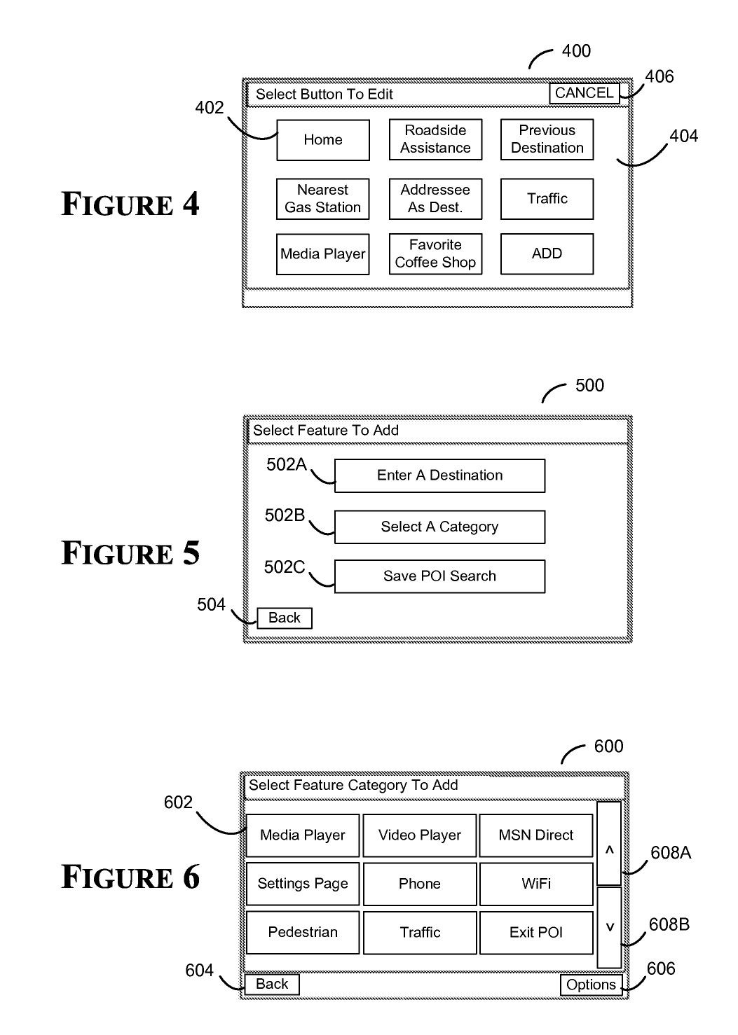

FIG. 4 provides an example of a screen 400 including an easy access panel presented to the user in response to user input to edit/add an easy access panel button in accordance with one or more embodiments of the present disclosure. In the example of FIG. 4, the easy access panel 404 includes a set of buttons 402. The selections include navigation-related selections, e.g., the “Home”, “Roadside Assistance”, “Previous Destination”, “Nearest Gas Station”, “Addressee As Destination”, and “Favorite Coffee Shop” buttons. The navigation-related buttons include buttons that allow the user to set a destination using a fixed destination associated with the button, e.g., the “Home”, “Previous Destination”, “Addressee As Destination”, and “Favorite Coffee Shop” buttons. In addition, the navigation-related buttons include buttons that allow the user to set a dynamic destination. By way of a non-limiting example, the “Nearest Gas Station” button causes a search of the geographic database to be performed, to identify one or more gas stations based on a set of criteria, at least one of which can be dynamically determined, e.g., a current location determined at the time of the search. In contrast to the “Favorite Coffee Shop” which corresponds to a fixed destination, the “Nearest Gas Station” button corresponds to a dynamically-generated destination identified based on current search criteria. In the case of the “Nearest Gas Station” button, the search is performed using criteria that may vary, e.g., the user's location as identified by the GPS 108. Other selections shown in the example of FIG. 4 include buttons that can be used to invoke an application, e.g., a media player application, a traffic application. In addition, the example of FIG. 4 includes an undefined button, e.g., the button labeled “ADD”.

In accordance with one or more embodiments, the user selects a previously-defined button to edit or a new button to add. As shown in FIG. 4, the user can select a button to edit, or the user can cancel the edit operation by selecting the “CANCEL” button 406. Referring again to FIG. 3B, processing continues at step 322 to await input from the user. If it is determined at step 322 that the received user input is to cancel the current edit/add operation, processing continues at step 304 to re-present the easy access panel. If it is determined, at step 324, that user input is received that indicates a button that is to be modified/added, processing continues at step 324 to present the user with one or more screens with which the user can edit/add the selected easy access button. At step 326, in a case that the user successfully edited/added the easy access button, processing continues at step 304 to display the easy access panel with the edited/added easy access button.

Alternatively, instead of exiting the edit/add operation and returning to the easy access panel if it is determined at step 322 that the user input is a cancel, the user can be presented with another opportunity to select a different button to edit. If the user input elects to proceed by selecting a different easy access button, processing continues at step 328 to present one or more screens to allow the user to edit the easy access panel and the selected button. At step 226, the easy access panel is modified based on the user input, and processing continues at step 304 to display the modified easy access panel.

By way of a non-limiting example and in accordance with one or more embodiments, a user can select from a number of categories to edit/add a button selected for editing/adding from the easy access panel. FIG. 5 provides a screen 500 showing examples of category selections that can be presented to the user in accordance with one or more embodiments. In the example, the user is asked to select from options that allow the user to associate the selected button with a user-specified destination 502A, a POI search 502C, or another operation selected from a number of feature categories 502B. The user can select one of items 502 or return to the previous screen by selecting button 504. By way of a non-limiting example and in a case that the user selects button 504, the easy access panel, e.g., the easy access panel 400, is presented to the user along with an option to select another button to edit/add.

Referring again to FIG. 5, in a case that the user selects “Select A Category” item 502B, the user is presented with a number of “categories”, e.g., category selections to associate an application or operation to a button of the easy access panel. FIG. 6 provides an example of a screen 600 and examples of selections 602 made available to the user in response to the user selecting the “Select A Category” item 502B in screen 500 of FIG. 5 in accordance with one or more embodiments of the present disclosure. In the example shown in FIG. 6, selecting from categories 602, the user can elect to associate the selected easy access button with a media player application, so that when the user selects the button in the easy access panel, the media player application is initiated. Other examples of category selections 602 included in FIG. 6 include selections to associate an easy access button with a video player application, a browser application and/or web site (e.g., “MSN Direct”), a phone application, traffic application, WiFi application, etc. In addition, the selected easy access button can be assigned to “jump to” a given screen of the user interface provided by system 100, e.g., a settings screen. As yet another non-limiting example, the selected easy access button can be assigned an operation to exit a POI operation. For example, in a case that the user is in the process of selecting a POI, the user can exit the POI selection by invoking the easy access panel and then selecting the easy access button to exit the POI operation. The user can scroll through the category selections using the scroll control buttons 608. In addition, the user can select from a set of options by selecting the “Options” button 606, or cancel the category selection and return to the previously-displayed screen, e.g., screen 500, by selecting the “Back” button 604.

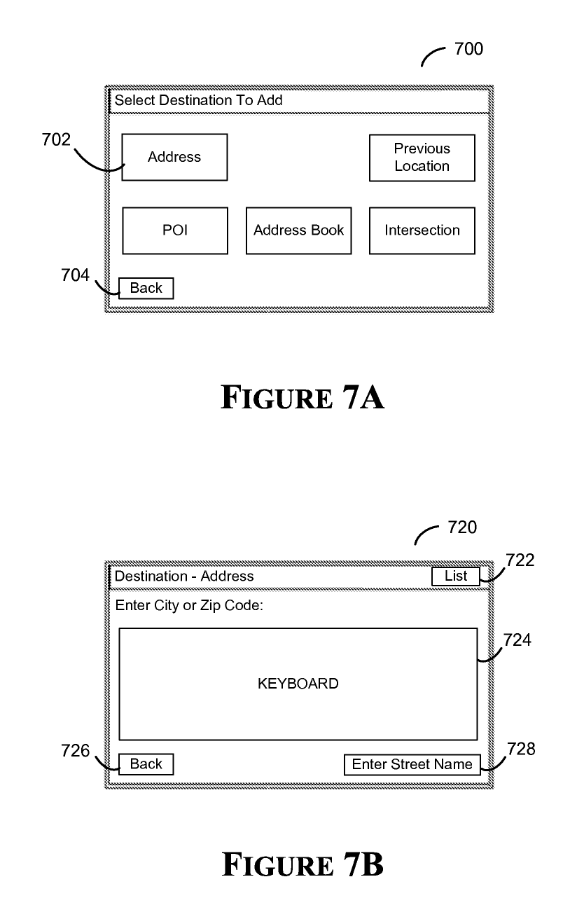

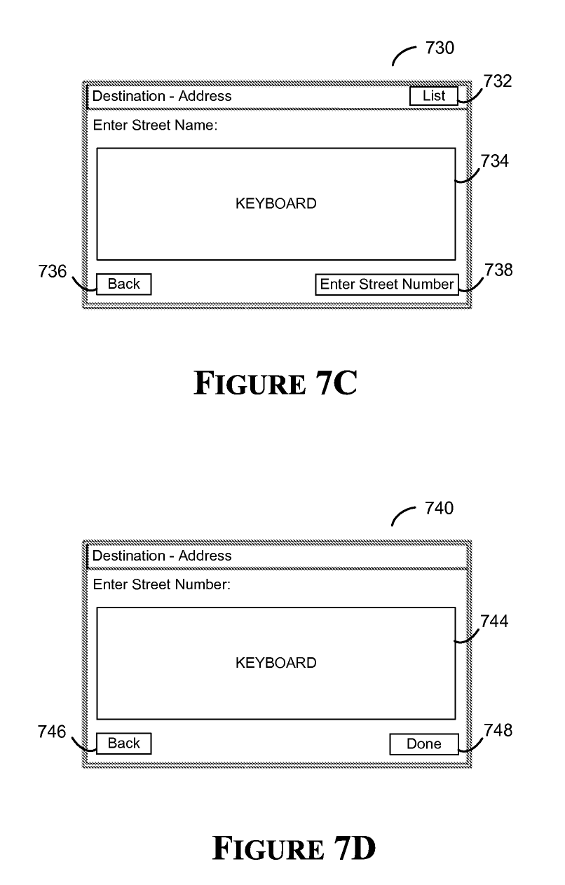

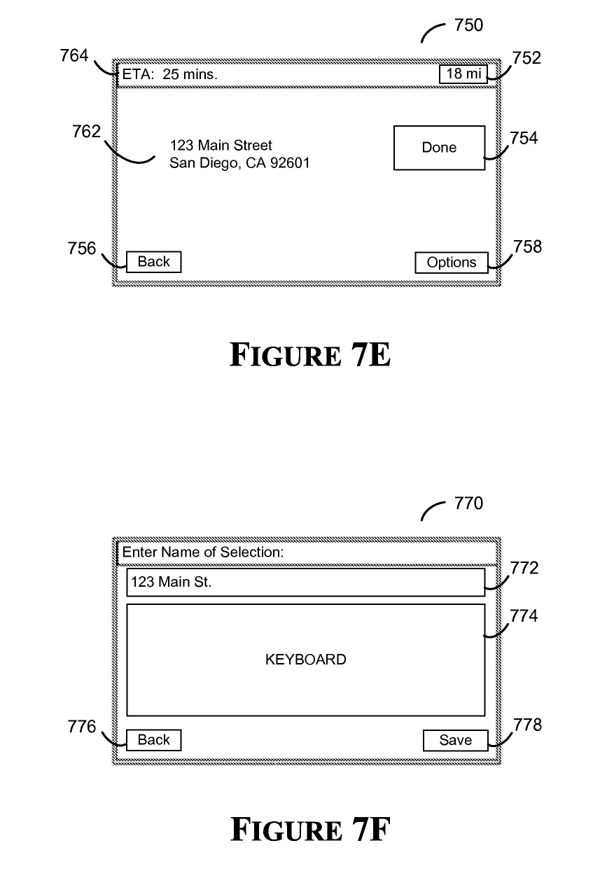

Referring again to FIG. 5, the user can assign a destination to the selected easy access button by selecting the “Enter A Destination” item 502A. FIG. 7A provides an example of a screen 700 presented to the user in response to a request to associate an easy access button with a destination in accordance with one or more embodiments of the disclosure. In the example shown in FIG. 7A, a screen 700 displays selections 702 the user can select to edit/add a button to the easy access panel. In the example shown in FIG. 7A, the user can select from items that allow the user to associate the easy access button with an address, a previous location, a POI, an address book, or an intersection. The user can return to screen 500 by selecting the “Back” button 704.

In a case that the user elects to specify a destination, or location, by its address, e.g., the user selects the “Address” button 702 in FIG. 7A, the user is presented with a series of screens, such as those shown in FIGS. 7B to 7D, to specify the location in accordance with one or more embodiments of the present disclosure.

Referring to FIG. 7B, the user is presented with a screen 720 and is prompted to enter the city or zip code of a location. The user is able to enter the zip code or city using a keyboard 724 or by selecting from a list. In the latter case, the user selects the list button 722, which results in the user being presented with a list of cities, or zip codes, from which the user can choose. The user has the option to return to the previous screen, e.g., screen 700 shown in FIG. 7A, by selecting the “Back” button 726 from screen 720, or to proceed to the next screen to enter a name of a street in the city specified by the user.

In response to the user selection of the “Enter Street Name” button 728, the system 100 presents the user with a screen, e.g., screen 730 of FIG. 7C, to allow the user to input the street name. The user can specify the street name using the displayed keyboard 734 or by selecting from a list of streets presented to the user in response to the user's selection of the “List” button 732. The user has the option to return to the previous screen, e.g., screen 720 shown in FIG. 7B, by selecting the “Back” button 736, or to proceed to the next screen to enter a street number on the user-specified street by selecting button 738. FIG. 7D provides an example of a screen 740 presented to the user to allow the user to enter the street number in accordance with one or more embodiments of the present disclosure. The user has the option to return to the previous screen, e.g., screen 730 of FIG. 7C, by selecting the “Back” button 746, or to input the street number using keyboard 744 and selecting the “Done” button 748.

FIG. 7E provides an example of a screen 750 that is displayed in response to a location specified by a user using the screens shown in FIGS. 7B to 7D in accordance with one or more embodiments of the present disclosure. The screen 750 identifies the user-specified location 762, an estimated time of arrival (ETA) 764, and a distance from a current location to the user-specified location 752. The “Options” button 758 allows the user to identify options to determine a route to the user-specified location, e.g., shortest time, shortest distance, minimize/maximize use of toll roads/freeways, etc. The user can return to screen 740 of FIG. 7D by pressing the “Back” button 756. In response to pressing the “Done” button 754 in FIG. 7E, the user is presented with a screen, e.g., screen 770 of FIG. 7F, which prompts the user to assign a label to the easy access button being edited/added. The label can be input using the keyboard 774, for example. The label can be assigned to the easy access button in response to the user inputting a string, e.g., “123 Main St.” using keyboard 774, and then pressing the “Save” button 778. The string input by the user is displayed in area 772 of screen 770. The user is also given an option to return to the previous screen, e.g., screen 750 of FIG. 7E, by pressing the “Back” button 776.

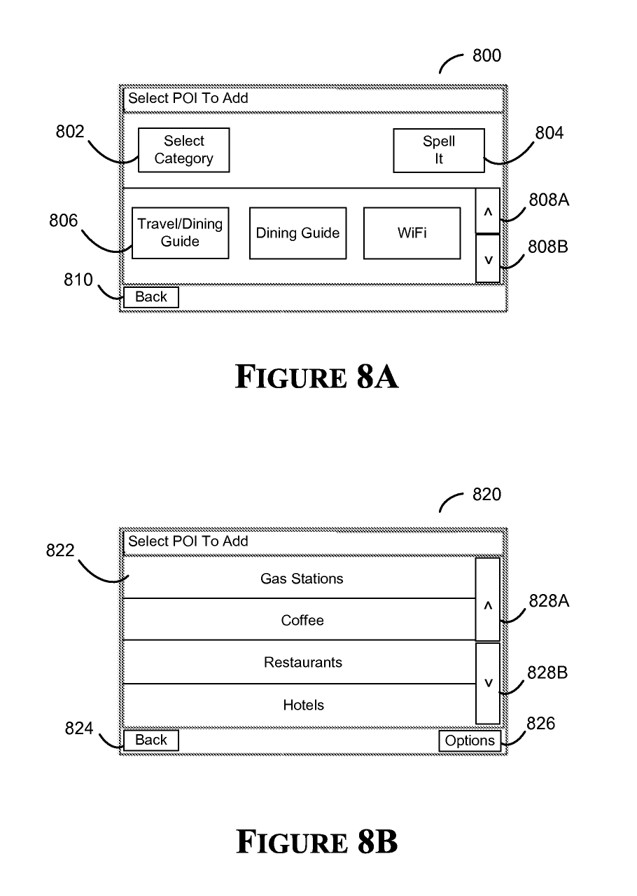

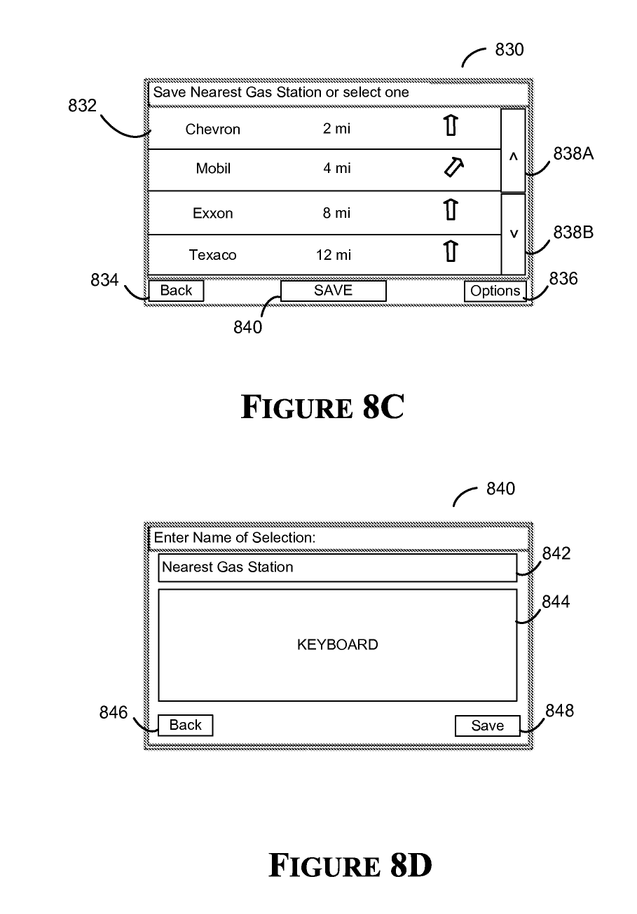

Referring again to FIG. 7A and in accordance with one or more embodiments, in response to the user selecting the “POI” button of buttons 702, the system 100 displays the screen 800 shown in FIG. 8A. The screen 800 allows the user to specify a POI to be associated with the selected easy access button. By way of some non-limiting examples, the user can specify a POI using a “Spell It” option 804, by specifying a category 802, using other sources 806, e.g., a guide book, e.g., an electronic travel/dining/tour guide available from the American Automobile Association (AAA), an electronic dining guide available from Zagat, and/or using a WiFi connection to identify a POI from information identified via a network and the WiFi connection, which can be scrolled through using buttons 808. The user can return to screen 700 of FIG. 7A by selecting the “Back” button 810.

In accordance with one or more embodiments, in a case that the user selects the “Select Category” button 802 of screen 800, the user can be presented with the screen 820 shown in FIG. 8B, which includes a number of POI category selections 822 selectable by the user. Examples of POI category selections 822 include without limitation gas stations, coffee shops, restaurants, hotels, etc. The user can return to screen 800 of FIG. 8A by selecting the “Back” button 824. The user has the ability to scroll through the list of POI categories using scroll buttons 828. In addition the user can specify options using the “Options” button 826.

FIG. 8C provides an example of a screen 830 that is presented to the user in a case that the user selects a POI category from the categories 822. In the example shown in FIG. 8C, the “Gas Stations” category 822 of screen 820 in FIG. 8B is selected by the user. In accordance with one or more embodiments, screen 830 of FIG. 8C provides an example of gas stations retrieved from the geographic database in response to selection of the “Gas Stations” category selection 822. The user can return to screen 820 by selecting the “Back” button 834, or to specify options by selecting the “Options” button 836. For example, the “Options” button allows the user to specify one or more options, such as to identify factors that are to be taken into account in locating the nearest gas station, such as a identifying the nearest gas station along a given route, near a given address, near a given destination, or nearest a given city. The user can scroll through the listings of gas stations presented via screen 830 using scroll buttons 838.

The user is able to indicate that the nearest gas station, e.g., a dynamic search is to be associated with the easy access button to allow the user to locate the nearest gas station each time the search is conducted in response to the user's selection of the easy access button. Alternatively, the user can that a selected one of the gas stations listed is to be associated with the selected easy access button. In either case, the user can provide a label to be associated with the selected easy access button using the screen 840 of FIG. 8D. In the example shown in FIG. 8D, the user elected to associate the selected easy access panel with a dynamic search to locate the nearest gas station, as discussed above with reference to the “Nearest Gas Station” button in the easy access panel shown in FIG. 4. The user enters the label via keyboard 844 and the label entered by the user is displayed in area 842 as the user enters it. The user can associate the operation, e.g., in this case a dynamic search to locate the closest gas station, and a label with the selected easy access button by selecting the “Save” button 848. The user can return to the previously-displayed screen, e.g., screen 830 of FIG. 8C, using the “Back” button 846.

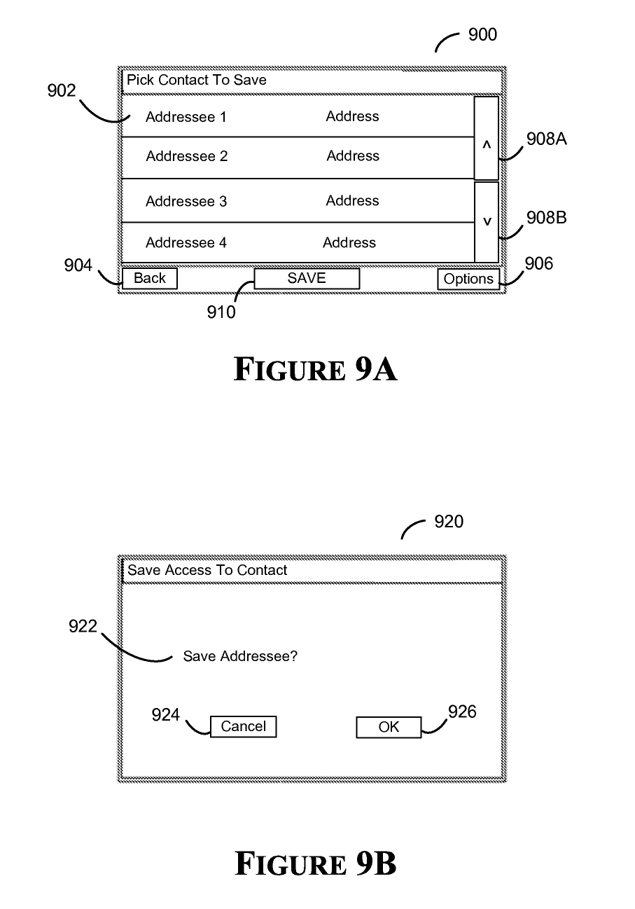

Referring again to FIG. 7A, a user can access a stored address book, e.g., an address book stored in memory 104 or an external memory coupled to the system 100, e.g., an address book available on a personal data assistant or other computing device's storage, by selecting the “Address Book” button 702 of screen 700. In response, the user is presented with a listing of addresses from the stored address book from which the user can select an address, or the addressee's entry in the address book, to be associated with the selected easy access button. FIGS. 9A and 9B provide examples of screens 900 and 920 (respectively) that are presented to the user in response to the user's selection of the “Address Book” button 702.

Referring to FIG. 9A, the user is provided with a list of address selections, or contacts, retrieved from the address book, from which the user can select an entry that the user wishes to associate with the selected easy access button. More particularly, the user is presented with a list 902 of saved contacts, from which the user is able to select a contact that is to be associated with the selected easy access button. Scroll buttons 908 can be used to scroll through the list 902. The “Options” button 906 provides the user with the ability to associate options with the selected address, such as options to be used to select a route to the selected address, e.g., shortest time, shortest destination, minimize or maximize toll roads/freeways, etc. The “Back” button 904 allows the user to return to the previously-displayed screen, e.g., screen 700 of FIG. 7A.

The user is able to save a selection using the “Save” button 910. In a case that the user selects the “Save” button 910, the user can be presented with a screen 920 of FIG. 9B, so that the user can input a label that is to be associated with the easy access button displayed in the easy access panel. The user is given the option to cancel the operation using the “Cancel” button 924 and is prompted to associate the selected addressee with the selected easy access button by selecting the “OK” button 926.

Referring again to FIG. 7A, in a case that the user wishes to edit/add an easy access button such that the easy access button is to be associated with an intersection as a location, the user can select the “Intersection” item 702. In response, system 100 provides the user with a series of screens to specify at least two intersecting streets. In accordance with one or more embodiments, the user can identify the intersecting streets using a keyboard or a listing of intersections, such as is discussed above with reference to specifying a street and/or city. In a case that the user selects the button 702 labeled “Previous Location” in screen 700, the user can be presented with a screen displaying a list of previous locations/destinations, which the user can scroll through to identify a previous location to associate with the selected easy access button.

Referring again to FIG. 5, in a case that the user elects to save a POI search by selecting selection 502C, the user can be presented with FIG. 8A in accordance with embodiments discussed hereinabove.

Embodiments of the present disclosure can be implemented within a general purpose microprocessor, or other processing device. If implemented in software, the techniques may be embodied as instructions, or program code, on a computer-readable medium such as random access memory (RAM), read-only memory (ROM), non-volatile random access memory (NVRAM), electrically erasable programmable read-only memory (EEPROM), FLASH memory, or the like. The instructions cause one or more processors to perform, and/or to be configured to perform, functionality described in this disclosure.

By way of further non-limiting examples, one or more disclosed embodiments might be implemented in part or in whole as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a microprocessor or other digital signal processing unit. The data storage medium may be an array of storage elements such as semiconductor memory (which may include without limitation dynamic or static RAM, ROM, and/or flash RAM) or ferroelectric, ovonic, polymeric, or phase-change memory; or a disk medium such as a magnetic or optical disk.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions, can be distributed among software applications at either the client or server level or both. In this regard, any number of the features of the different embodiments described herein may be combined into single or multiple embodiments, and alternate embodiments having fewer than or more than all of the features herein described are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter. The disclosure is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A computer-implemented method comprising:
generating, as part of a navigation system's user interface having a plurality of screens, an access screen selector that is made available in multiple ones of the plurality of screens, the access screen selector corresponding to an access screen; and
displaying the access screen as a part of the user interface in response to user selection of the access screen selector, the access screen comprising one or more access selection items, selection of at least one of the access selection items causes the navigation system to perform a search of geographic information to identify a search result using search criteria that can vary from one search to another.

2. The method of claim 1, further comprising:
receiving user input requesting a change to a selected one of the access selection items of the access screen; and
updating the access screen to reflect the requested change.

3. The method of claim 1, wherein the search result comprises at least one destination identified using the geographic information and the search criteria.

4. The method of claim 3, wherein the search criteria comprises a current location of a device executing the navigation system, the current location being determined using a global positioning system coupled to the device.

5. The method of claim 1, wherein the search criteria can vary based on a timing of selection of the at least one access selection item.

6. The method of claim 1, wherein in addition to the at least one access selection item that causes the navigation system to perform a search of geographic information using search criteria that can vary, the access screen includes another access selection item that causes the navigation system to perform a search of geographic information using fixed search criteria in response to selection of the other access selection item.

7. The method of claim 1, further comprising:
executing an application associated with an access selection item included in the one or more access selection items of the access screen in response to selection of the application access selection item.

8. The method of claim 1, wherein selection of the at least one access selection item causes the navigation system to perform a search of geographic information to identify a point of interest nearest to a current location.

9. A computer-readable medium storing program code comprising code to configure at least one device to:
generate, as part of a navigation system's user interface having a plurality of screens, an access screen selector that is made available in multiple ones of the plurality of screens, the access screen selector corresponding to an access screen; and
display the access screen as a part of the user interface in response to user selection of the access screen selector, the access screen comprising one or more access selection items, selection of at least one of the access selection items causes the navigation system to perform a search of geographic information to identify a search result using search criteria that can vary from one search to another.

10. The medium of claim 9, the program code further comprising code to configure at least one device to:
receive user input requesting a change to a selected one of the access selection items of the access screen;
update the access screen to reflect the requested change.

11. The medium of claim 9, wherein the search result comprises at least one destination identified using the geographic information and the search criteria.

12. The medium of claim 11, wherein the search criteria comprises a current location of a device executing the navigation system, the current location being determined using a global positioning system coupled to the device.

13. The medium of claim 9, wherein the search criteria can vary based on a timing of selection of the access selection item.

14. The medium of claim 9, wherein in addition to the at least one access selection item that causes the navigation system to perform a search of geographic information using search criteria that can vary, the access screen includes another access selection item that causes the navigation system to perform a search of geographic information using fixed search criteria in response to selection of the other access selection item.

15. The medium of claim 9, the program code further comprising code to configure at least one device to:
execute an application associated with an access selection item included in the one or more access selection items of the access screen in response to selection of the application access selection item.

16. The medium of claim 9, wherein selection of the at least one access selection item causes the navigation system to perform a search of geographic information to identify a point of interest nearest to a current location.

17. A system comprising:
at least one processor configured to:
generate, as part of the system's user interface having a plurality of screens, an access screen selector that is made available in multiple ones of the plurality of screens, the access screen selector corresponds to an access screen; and
display the access screen as a part of the user interface in response to user selection of the access screen selector, the access screen comprising one or more access selection items, selection of at least one of the access selection items causes the navigation system to perform a search of geographic information to identify a search result using search criteria that can vary from one search to another.

18. The system of claim 17, the at least one processing further configured to:
receive user input requesting a change to a selected one of the access selection items of the access screen; and
update the access screen to reflect the requested change.

19. The system of claim 17, wherein the search result comprises at least one destination identified using the geographic information and the search criteria.

20. The system of claim 19, wherein the search criteria comprises a current location of a device executing the navigation system, the current location being determined using a global positioning system coupled to the device.

21. The system of claim 17, wherein the search criteria can vary based on a timing of selection of the at least one access selection item.

22. The system of claim 17, wherein in addition to the at least one access selection item that causes the navigation system to perform a search of geographic information using search criteria that can vary, the access screen includes another access selection item that causes the navigation system to perform a search of geographic information using fixed search criteria in response to selection of the other access selection item.

23. The system of claim 17, the at least one processor further configured to:
execute an application associated with an access selection item included in the one or more access selection items of the access screen in response to selection of the application access selection item.

24. The system of claim 17, wherein selection of the at least one access selection item causes the navigation system to perform a search of geographic information to identify a point of interest nearest to a current location.

25. A user interface comprising:
a plurality of screens as part of a navigation system's user interface, multiple ones of the plurality of screens making an access screen selector available, the access screen selector corresponding to an access screen; and
the access screen as a part of the user interface that is displayed in response to user selection of the access screen selector, the access screen comprising one or more access selection items, selection of at least one of the access selection items causes the navigation system to perform a search of geographic information to identify a search result using search criteria that can vary from one search to another.
